(19) United States
(12) Patent Application Publication
(10) Pub. No.: US 2024/0380146 A1
(43) Pub. Date: Nov. 14, 2024

(54) ELECTRICAL CONNECTOR

(71) Applicant: HIROSE KOREA CO., LTD., Siheung-si (KR)

(72) Inventor: Sang Gi PARK, Siheung-si (KR)

(73) Assignee: HIROSE KOREA CO., LTD., Siheung-si (KR)

(21) Appl. No.: 18/661,642

(22) Filed: May 12, 2024

(30) Foreign Application Priority Data
May 11, 2023 (KR) 10-2023-0061220

(51) Int. Cl. H01R 13/02; H01R 13/502

(52) U.S. Cl. CPC H01R 13/02; H01R 13/502

(57) ABSTRACT

An electrical connector coupled to a mating connector. The electrical connector includes: a housing; a signal terminal; and a power terminal. The housing includes first to fourth walls and a skirt protruding outwards in a transverse direction of the connector. The electrical connector includes a plurality of first signal terminals and a plurality of second signal terminals formed at least on the first wall and arranged in a longitudinal direction of the electrical connector. The first signal terminal includes a first bent portion, a first elongated portion, and a first tail. The second signal terminal includes a second bent portion, a second elongated portion, and a second tail. The first tail and the second tail are disposed at the skirt. A lowermost surface of the first tail is higher than a lowermost surface of the second tail in a height direction of the electrical connector.

### TECHNICAL FIELD

The present invention relates to an electrical connector. More particularly, the present invention relates to shapes of signal terminals of an electrical connector (a plug connector or a receptacle connector (socket connector)), arrangement of the signal terminals, and a relationship between the signal terminals and a housing of the electrical connector.

### BACKGROUND

Generally, interconnection between substrates is established using two connectors that are connected to respective substrates by soldering or the like and are connectable to each other. Here, one of the two connectors is a plug connector and the other is a socket connector. The socket connector is also referred to as a receptacle connector. Such plug and socket connectors may be formed by disposing terminals in a molded part. The plug connector and the socket connector may be fastened to each other to form an electrical connector assembly.

With the trend toward miniaturization of electronic devices, connectors have increasingly become compact in size and height. However, there are certain limitations in making a connector compact in size and height by reducing a pitch between electrical terminals or by downsizing related components.

Miniaturization of connectors makes it more difficult than before to ensure durability thereof. Such connectors are more prone to breakage or deformation under a smaller force due to reduced rigidity thereof.

In addition, miniaturization of connectors can increase the probability of misassembly. In the case of large connectors, fitting between a pair of connectors requires relatively great force, making it difficult to fit the connectors into each other in the wrong direction, whereas, in the case of tiny connectors, fitting between a pair of connectors requires little force, making possible fitting in the wrong direction (reverse mating), regardless of the shape of the pair of connectors.

In addition, two mating connectors can undergo plastic deformation if metal terminals thereof continue to retain a certain shape during or after the process of connecting the connectors to each other. Plastic deformation is the opposite of elastic deformation and refers to irreversible deformation or changes in shape of a material retained after removal of applied load. Even with elasticity, most materials usually undergo deformation when exposed to stress. Therefore, there is a need for a solution to prevent plastic deformation that can occur in connector terminals, which are becoming increasingly reduced in size.

A resin-molded part (housing) of a connector is often manufactured by insert molding. Here, fluidity of a resin used is critical to proper molding of the housing. Therefore, there is a need to improve fluidity of the resin.

In addition, in manufacture of metal terminals, the structures of the terminals and the resin-molded part are limited depending on the manufacturing method thereof (for example, whether deep drawing is used). Therefore, there is a need to consider these points.

Further, during an insert molding process or the like, an injected resin can cover a metal material. Therefore, there is a need to consider this problem.

### SUMMARY

It is one aspect of the present invention to prevent electrical short between adjacent terminals during a surface mount technology (SMT) process.

To this end, the present invention uses a height difference (H) between adjacent terminals.

It is another aspect of the present invention to prevent solder wicking during the SMT process

That is, the present invention prevents solder wicking through a combination of the height difference (H) and a second groove (10-5-G2) having a relatively large width.

It is a further aspect of the present invention to provide prevention of solder wicking and electrical short between adjacent terminals without increasing complexity of a manufacturing process by forming a structure providing these effects without using a separate process.

It is yet another aspect of the present invention to provide prevention of short shot defects and correction of the position of terminals by designing the shape of a first groove (10-5-G1) around a first tail (10-3A-T1) to serve the intended purpose.

It is yet another aspect of the present invention to ensure that a mounting pitch is greater than a pitch between adjacent signal terminals (10-3) by arranging two or more types of signal terminals (10-3) in an alternate manner (for example, in a zigzag pattern).

It should be understood that aspects of the present invention are not limited to the above. The above and other aspects of the present invention will become apparent to those skilled in the art from the detailed description of the following embodiments.

In accordance with an aspect of the present invention, there is provided an electrical connector coupled with a mating connector, including: a housing including a base, a first wall protruding from an upper surface of the base, a second wall protruding from the upper surface of the base and intersecting the first wall, a third wall protruding from the upper surface of the base, intersecting the second wall, and facing the first wall, a fourth wall protruding from the upper surface of the base, intersecting the first and third walls, and facing the second wall, and a skirt protruding outwards from the first and third walls in a transverse direction of the electrical connector; and a plurality of first signal terminals and a plurality of second signal terminals formed at least on the first wall and arranged in a longitudinal direction of the electrical connector, wherein the first signal terminal includes a first bent portion, a first elongated portion, and a first tail, the second signal terminal includes a second bent portion, a second elongated portion, and a second tail, the first tail and the second tail are disposed at the skirt, and a lowermost surface of the first tail is higher than a lowermost surface of the second tail in a height direction of the electrical connector.

Preferably, the first tail is not mounted on a substrate, and the second tail is mounted on the substrate.

Preferably, the second tail protrudes farther than the first tail in the transverse direction of the electrical connector.

Preferably, the skirt includes a first groove formed above the first tail, wherein the first groove has a cut-out such that an upper surface of the first tail is partially exposed through the cut-out of the first groove in top view.

Preferably, the first groove has a semicircular shape in side view.

Preferably, the skirt includes a second groove formed under the first tail such that a lower surface of the first tail is at least partially exposed through the second groove in bottom view.

Preferably, the second groove has a rectangular shape in side view.

Preferably, the first elongated portion and the second elongated portion serve as contacts with a signal terminal of the mating connector.

Preferably, the first signal terminal and the second signal terminal are arranged alternately in the longitudinal direction of the electrical connector.

Preferably, the first signal terminal further includes a third elongated portion and a third tail.

According to the present invention, as described in FIG. 4A and FIG. 4B, the third tail (10-3A-T3) of the first signal terminal (10-3A) and the second tail (10-1B-T2) of the second signal terminal (10-3B) are used as mounting portions (10-3A-M, 10-3B-M), respectively, wherein a lower surface of the third tail (10-3A-T3) is flush with a lower surface of the second tail (10-1B-T2). In addition, a lower surface of the first tail (10-3A-T1) of the first signal terminal (10-3A) is higher by H than the lower surface of the third tail (10-3A-T3) and does not serve as a mounting portion. The purpose of this height difference H is to prevent electrical short between adjacent terminals during a surface mount technology (SMT) process.

Solder paste or the like is used in SMT to join the second tail (10-3B-T2) of the second signal terminal (10-3B) to a substrate (not shown). For example, when the connector (10) according to the present invention has a very small size to be used in applications such as smartphones, solder paste applied to the second tail (10-3B-T2) can spread to the vicinity of another terminal adjacent thereto (that is, the first tail (10-3A-T1) of the first signal terminal (10-3A)). This can result in electrical short between the terminals due to undesirable circuit connection. In order to prevent such electrical short, in the present invention, the first tail (10-3A-T1) (not serving as a mounting portion) is positioned higher by H than the second tail (10-3B-T2) (serving as a mounting portion), as shown in FIG. 7.

In addition, at least some of the height difference H corresponds to a height (depth) of the second groove 10-5-G2. Forming the second groove (10-5-G2) having a shape as shown in FIG. 5 to FIG. 7 can prevent solder wicking. That is, although the second groove (10-5-G2) does not serve to actively trap solder paste therein, when a small amount of solder paste inevitably spreads sideways from a portion of a neighboring terminal (that is, the second tail (10-3B-T2)), the second groove (10-5-G2) or a region under the second groove (10-5-G2) can retain (or trap) some of the solder paste, thereby preventing the solder paste from reaching the first tail (10-3A-T1) (unless a large amount of the solder paste spreads from the neighboring terminal). In this way, the second groove (10-5-G2) can prevent electrical short between adjacent terminals.

That is, the height difference H and the relatively wide second groove (10-5-G2) cooperatively prevent solder wicking.

Advantageously, the first groove (10-5-G1) and/or the second groove (10-5-G2) can serve to prevent solder wicking and thus electrical short between adjacent terminals while eliminating the need to increase the number of processes since the first groove (10-5-G1) and the second groove (10-5-G2) are formed by holding the first signal terminal (10-3A) with tools having shapes corresponding thereto during a resin molding process without requiring a separate process. In short, the present invention can provide prevention of solder wicking and prevention of electrical short between adjacent terminals while not increasing the complexity of the manufacturing process.

In addition, it can be seen that the first groove (10-5-G1) has a rounded shape. This rounded shape can serve to prevent a short shot, that is, incomplete filling of a space around the first tail (10-3A-T1) stepped with respect to (having a height difference H from) the mounting portion (that is, the second tail (10-3B-T2)) while aiding in correcting the position of the terminals.

That is, when only a linear portion of the upper surface of the first tail (10-3A-T1) is exposed due to the rounded shape of the first groove (10-5-G1), the first groove can not only more firmly held the first signal terminal (10-3A) (especially, the first tail (10-3A-T1)), but also can aid in correcting the position of the first tail (10-3A-T1), as compared with when the upper surface of the first tail (10-3A-T1) is entirely exposed.

For reference, unlike the illustrated example, the second groove (10-5-G2) may have a rounded shape and the first groove (10-5-G1) may have a rectangular shape. However, in this case, the solder wicking prevention effect provided by the second groove (10-5-G2) is somewhat weakened. Since the second tail (10-3B-T2) is soldered on the lower surface thereof rather than on the upper surface thereof, there is a greater need to prevent solder wicking onto the lower surface of the first tail (10-3A-T1). Accordingly, it is desirable that the second groove (10-5-G2) have a rectangular shape to expose a relatively large area of the first tail (10-3A-T1) so as to prevent solder wicking and the first groove (10-5-G1) have a rounded shape to expose a relative small area of the first tail (10-3A-T1) so as to prevent short shot defects (that is, to ensure that a resin sufficiently covers the first tail (10-3A-T1)) and to aid in correcting the position of the first tail (10-3A-T1) (that is, positioning the first tail (10-3A-T1) in place), although the present invention is not limited thereto.

As best seen in FIG. 2, although also shown in FIG. 1, two types of signal terminals (10-3) are arranged alternately. That is, the two types of signal terminals (10-3) are arranged alternately in the longitudinal direction of the connector (10) (X-direction), such that a mounting portion (10-3A-M) disposed at an inner side of the connector (10) in the transverse direction thereof (to be visible through a through-hole (10-5-PH)) is alternated with a mounting portion (10-3B-M) disposed at an outer side of the connector (10) in the transverse direction thereof, although the present invention is not limited thereto. In addition, as for the multiple mounting portions (10-3A-M) disposed at the inner side of the connector (10) in the transverse direction thereof (Y-direction), mounting portions (10-3A-M) of signal terminals (10-3A) disposed on the first wall (10-5-W1) form a zigzag pattern with mounting portions (10-3A-M) of signal terminals (10-3A) disposed on the third wall (10-5-W3), as shown in FIG. 2. In addition, as for the multiple mounting portions (10-3B-M) disposed at the outer side of the connector (10) in the transverse direction thereof (Y-direction), mounting portions (10-3B-M) of signal terminals (10-3B) disposed on the first wall (10-5-W1) form a zigzag pattern with mounting portions (10-3B-M) of signal terminals (10-3B) disposed on the third wall (10-5-W3), as shown in FIG. 2. Accordingly, a mounting pitch is greater than a pitch between adjacent signal terminals (10-3) (the mounting pitch is about twice the pitch between adjacent signal terminals (10-3)), making it possible to fit many signal terminals 10-3 into a small space. The zigzag arrangement of the mounting portions (10-3A-M) of the signal terminals (10-3) can be easily seen through the through-hole (10-5-PH).

It should be understood that advantageous effects of the present invention are not limited to the above.

The above and other advantageous effects of the present invention will become apparent to those skilled in the art from the detailed description of the following embodiments.

### BRIEF DESCRIPTION OF THE DRAWINGS

The above and other aspects, features, and advantages of the present invention will become apparent from the detailed description of the following embodiments in conjunction with the accompanying drawings:

FIG. 1 is a perspective view of a plug connector 10 among electrical connectors according to the present invention;

FIG. 2 is a top view of the plug connector 10 of FIG. 1;

FIG. 3 is a side view of the plug connector 10 of FIG. 1;

FIG. 4A is a view of one first signal terminal 10-3A disposed along line AB of FIG. 1 and FIG. 2;

FIG. 4B is a view of one second signal terminal 10-3B disposed along line CD of FIG. 1 and FIG. 2;

FIG. 5 is a partial enlarged view of the plug connector 10 according to the present invention;

FIG. 6 is a view of the plug connector of FIG. 5 taken from another angle;

FIG. 7 is a view of the plug connector of FIG. 5 taken from yet another angle, and is also a part of the side view of FIG. 3; and

FIG. 8 is a view of the plug connector of FIG. 5 to FIG. 7 taken from yet another angle.

### DETAILED DESCRIPTION OF EMBODIMENTS

Hereinafter, exemplary embodiments of the present invention will be described with reference to the accompanying drawings. It should be understood that the present invention is not limited to the following embodiments and may be embodied in different ways, and that the embodiments are provided for complete disclosure and thorough understanding of the present invention by those skilled in the art. The scope of the present invention is defined only by the claims. Like components will be denoted by like reference numerals throughout the specification.

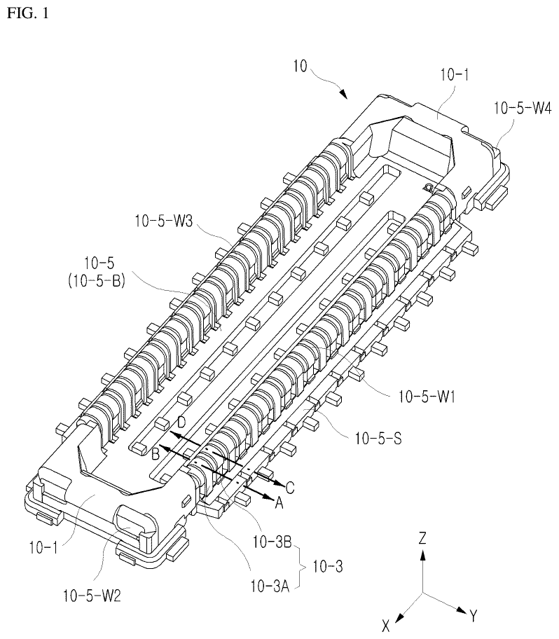

FIG. 1 is a perspective view of an example of a plug connector 10 among electrical connectors according to the present invention.

As used herein, the term “electrical connector” may refer to a plug connector 10, a receptacle connector (not shown) (also referred to as a “socket connector”), or both the plug connector 10 and the receptacle connector (not shown) (or an assembly thereof), as the context indicates.

Referring to FIG. 1, the plug connector 10 includes a power terminal 10-1 (also referred to as a “fitting terminal” or a “fitting), a signal terminal 10-3, and a housing 10-5 (a molded part).

The power terminal 10-1 (the fitting) is a metal structure that reinforces the connector 10. The power terminal 10-1 allows input/output of electrical power signals. FIG. 1 shows an example in which the fitting is integrally formed with the power terminal. However, the present invention is not limited thereto and the fitting may be provided as a separate member from the power terminal.

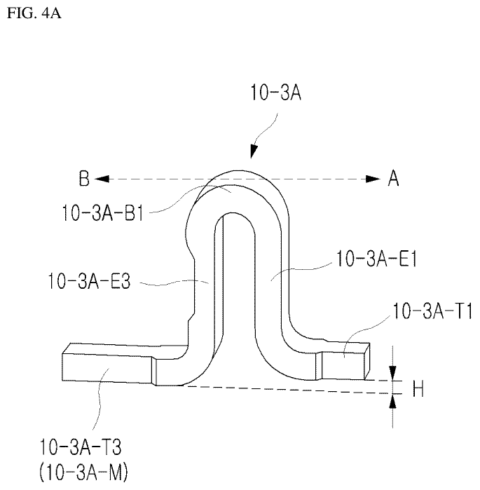

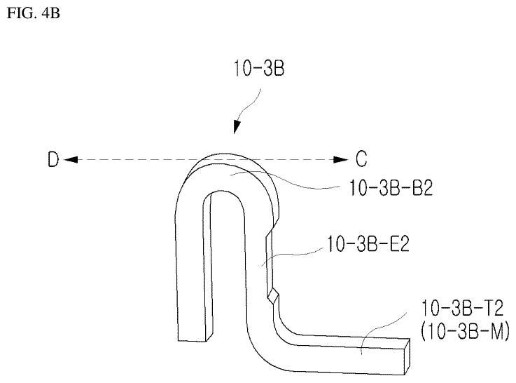

The signal terminal 10-3 allows input/output of data signals. In this embodiment, the signal terminal 10-3 includes two types of signal terminals (that is, a first signal terminal 10-3A and a second signal terminal 10-3B). Details thereof will be described below with reference to FIG. 4A, FIG. 4B, and the like.

For example, the signal terminal 10-3 may include four pins capable of carrying a current of 0.3 A, or may be a terminal capable of carrying a current of greater than 0.3 A, for example, a current of up to 5 A, to function as a power terminal. Although the signal terminal is described as including four pins, the present invention is not limited thereto. For reference, in the example illustrated in FIG. 1, the plug connector includes 44 signal terminals 10-3 (22 first signal terminals 10-3A and 22 second signal terminals 10-3B).

The housing 10-5 has a base 10-5-B. In addition, the housing 10-5 has a wall protruding from an upper surface of the base. The power terminal 10-1 (the fitting), the signal terminal 10-3, and the like are formed on the wall.

The wall includes four walls, that is, a first wall 10-5-W1, a second wall 10-5-W2, a third wall 10-5-W3, and a fourth wall 10-5-W4. As shown in FIG. 1, the four walls are connected to one another in a sequence of the first wall 10-5-W1/the second wall 10-5-W2/the third wall 10-5-W3/the fourth wall 10-5-W4 and the fourth wall 10-5-W4 is in turn connected to the first wall 10-5-W1. Referring to FIG. 1, the plug connector has a generally rectangular shape, wherein the first wall 10-5-W1 and the third wall 10-5-W3 are side walls and the second wall 10-5-W2 and the fourth wall 10-5-W4 are short walls.

The housing 10-5 (the molded part) of the plug connector 10 may be formed of a plastic material, for example, a liquid crystal polymer (LCP). Alternatively, the housing 10-5 may be formed of an insulator, such as a resin and an epoxy, without being limited thereto. The power terminal 10-1 and the signal terminal 10-3 of the plug connector 10 may be formed of a metal, for example, copper or a gold-plated copper alloy (with a nickel underlayer), without being limited thereto.

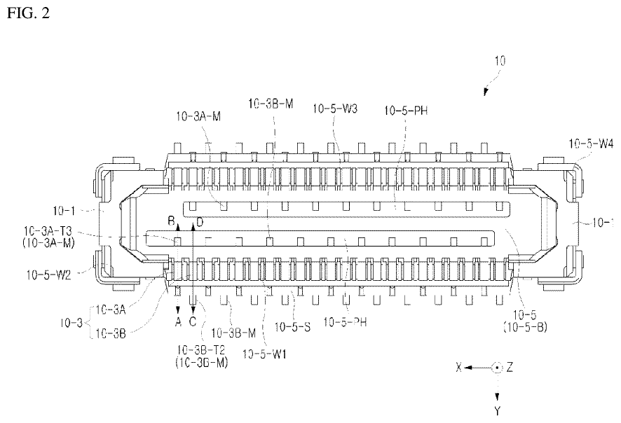

FIG. 2 is a top view of the plug connector 10 of FIG. 1.

As best seen in FIG. 2, although also shown in FIG. 1, the two types of signal terminals 10-3 are arranged alternately.

That is, the two types of signal terminals 10-3 are arranged alternately in a longitudinal direction of the connector 10 (X-direction) such that a mounting portion 10-3A-M disposed at an inner side of the connector 10 in a transverse direction thereof (to be visible through a through-hole 10-5-PH) is alternated with a mounting portion 10-3B-M disposed at an outer side of the connector 10 in the transverse direction thereof, although the present invention is not limited thereto.

Referring to FIG. 4A described below, the mounting portion 10-3A-M of the first signal terminal 10-3A may also be referred to as a third tail 10-3A-T3.

Referring to FIG. 4B described below, the mounting portion 10-3B-M of the second signal terminal 10-3B may also be referred to as a second tail 10-3B-T2.

In addition, as for the multiple mounting portions 10-3A-M disposed at the inner side of the connector 10 in the transverse direction of the connector 10 (Y-direction), mounting portions 10-3A-M of signal terminals 10-3A disposed on the first wall 10-5-W1 form a zigzag pattern with mounting portions 10-3A-M of signal terminals 10-3A disposed on the third wall 10-5-W3, as shown in FIG. 2.

In addition, as for the multiple mounting portions 10-3B-M disposed at the outer side of the connector 10 in the transverse direction of the connector 10 (Y-direction), mounting portions 10-3B-M of signal terminals 10-3B disposed on the first wall 10-5-W1 form a zigzag pattern with mounting portions 10-3B-M of signal terminals 10-3B disposed on the third wall 10-5-W3, as shown in FIG. 2.

Accordingly, a mounting pitch is greater than a pitch between adjacent signal terminals 10-3 (the mounting pitch is about twice the actual pitch between adjacent signal terminals 10-3), making it possible to fit many signal terminals 10-3 into a small space.

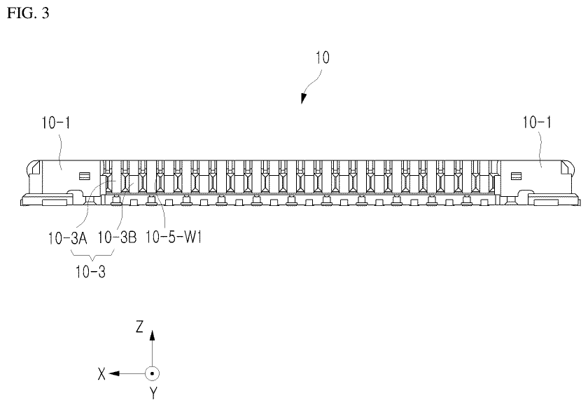

FIG. 3 is a side view of the plug connector 10 of FIG. 1.

Referring to FIG. 3, it can be seen that the first signal terminal 10-3A and the second signal terminal 10-3B as the signal terminal 10-3 are arranged alternately.

Although FIG. 1 to FIG. 3 show an example in which one first signal terminal 10-3A and one second signal terminal 10-3B are arranged alternately, the present invention is not limited thereto and any other arrangement is possible. For example, one first signal terminal 10-3A and two second signal terminals 10-3B may be arranged alternately in a row, or the two types of signal terminals may be arranged in an irregular order. In addition, the signal terminal does not necessarily include two types of signal terminals, but may include three or more types of signal terminals.

However, in terms of layout optimization, it is desirable that one first signal terminal 10-3A and one second signal terminal 10-3B be arranged alternately and mounting portions of signal terminals disposed on different walls (the first wall 10-5-W1 and the third wall 10-5-W3) form a zigzag pattern.

FIG. 4A is a view of one first signal terminal 10-3A disposed along line AB of FIG. 1 and FIG. 2.

In FIG. 4A, the right side corresponds to the transverse outer side of the connector 10, and the left side corresponds to the transverse inner side of the connector 10. In a direction from the transverse outer side of the connector to the transverse inner side of the connector, the first signal terminal 10-3A has a first tail 10-3A-T1/a first elongated portion 10-3A-E1/a first bent portion 10-3A-B1/a third elongated portion 10-3A-E3/a third tail 10-3A-T3.

The third tail 10-3A-T3 serves as a mounting portion 10-3A-M with respect to a substrate (not shown).

A lower end of the first tail 10-3A-T1 is higher by H than a lower end of the third tail 10-3A-T3 (that is, the mounting portion 10-3A-M). Accordingly, the first tail 10-3A-T1 does not serve as a mounting portion with respect to the substrate.

FIG. 4B is a view of one second signal terminal 10-3B disposed along line CD of FIG. 1 and FIG. 2.

In FIG. 4B, the right side corresponds to the transverse outer side of the connector 10 and the left side corresponds to the transverse inner side of the connector 10. In a direction from the transverse outer side of the connector to the transverse inner side of the connector, the second signal terminal 10-3B has a second tail 10-3B-T2/a second elongated portion 10-3B-E2/a second bent portion 10-3B-B2.

The second tail 10-3B-T2 serves as a mounting portion 10-3B-M with respect to a substrate (not shown).

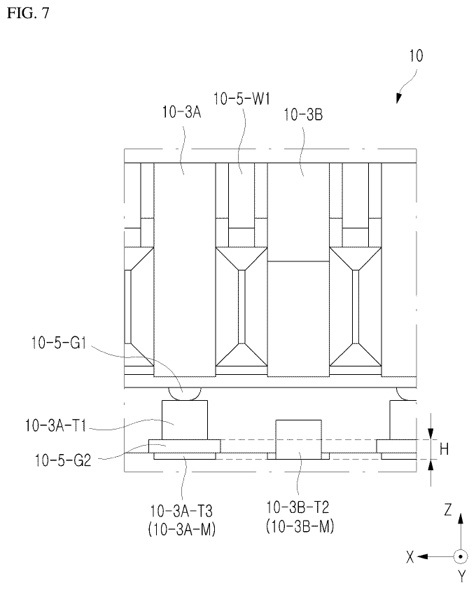

With regard to the first signal terminal 10-3A of FIG. 4A, it has been described that the lower end of the first tail 10-3A-T1 is higher by H than the lower end of the third tail 10-3A-T3 (that is, the mounting portion 10-3A-M). Since the lower end of the second tail 10-3B-T2 of the second signal terminal 10-3B is flush with the lower end of the third tail 10-3A-T3 of the first signal terminal 10-3A, there is a height difference H between the lower end of the first tail 10-3A-T1 of the first signal terminal 10-3A and the lower end of the second tail 10-3B-T2 of the second signal terminal 10-3B (see FIG. 7 and the like described further below).

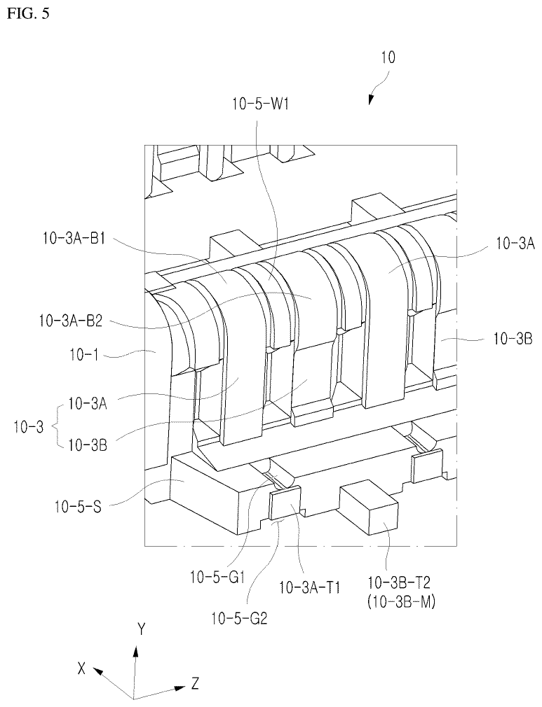

FIG. 5 is a partial enlarged view of the plug connector 10 according to the present invention.

As shown in FIG. 1, FIG. 2, and FIG. 5, the housing 10-5 has a portion protruding outwards in a transverse direction thereof, which is referred to as a skirt 10-5-S.

The skirt 10-5-S covers the first tail 10-3A-T1 of the first signal terminal 10-3A. In addition, the skirt 10-5-S also covers the second tail 10-3B-T2 of the second signal terminal 10-3B.

More specifically, upper and side surfaces of the second tail 10-3B-T2 of the second signal terminal 10-3B are mostly covered by the skirt 10-5-S, and a portion of the side surface of the second tail 10-3B-T2 and a lower surface of the second tail 10-3B-T2 are exposed. The exposed lower surface of the second tail 10-3B-T2 serves as a mounting surface of the mounting portion 10-3B-M.

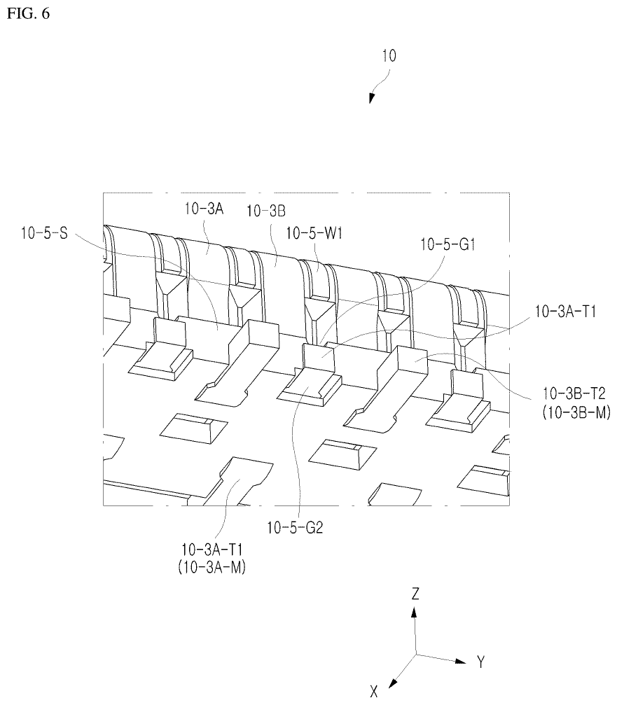

This structure shown in FIG. 5 can also be seen from FIG. 6 described below.

In addition, a side surface of the first tail 10-3A-T1 of the first signal terminal 10-3A is mostly covered by the skirt 10-5-S, a lower surface of the first tail 10-3A-T1 is substantially entirely exposed through a generally rectangular groove (a second groove 10-5-G2), and an upper surface of the first tail 10-3A-T1 is partially exposed through a rounded groove (a first groove 10-5-G1).

This structure shown in FIG. 5 can also be seen from FIG. 6 described below.

FIG. 6 is a view of the plug connector of FIG. 5, taken from another angle.

These structures described in FIG. 5 will be more clearly understood with reference to FIG. 6.

That is, the skirt 10-5-S covers both the first tail 10-3A-T1 of the first signal terminal 10-3A and the second tail 10-3B-T2 of the second signal terminal 10-3B.

More specifically, the upper and side surfaces of the second tail 10-3B-T2 of the second signal terminal 10-3B are mostly covered by the skirt 10-5-S, and a portion of the side surface of the second tail 10-3B-T2 and the lower surface of the second tail 10-3B-T2 are exposed. The exposed lower surface of the second tail 10-3B-T2 serves as a mounting surface of the mounting portion 10-3B-M.

In addition, the side surface of the first tail 10-3A-T1 of the first signal terminal 10-3A is mostly covered by the skirt 10-5-S, the lower surface of the first tail 10-3A-T1 is substantially entirely exposed through the generally rectangular groove (the second groove 10-5-G2), and the upper surface of the first tail 10-3A-T1 is partially exposed through the rounded groove (the first groove 10-5-G1).

FIG. 7 is a view of the plug connector of FIG. 5 taken from yet another angle, and is also a part of the side view of FIG. 3.

As described in FIG. 4A and FIG. 4B, the third tail 10-3A-T3 of the first signal terminal 10-3A and the second tail 10-1B-T2 of the second signal terminal 10-3B serve as the mounting portions 10-3A-M, 10-3B-M, respectively, wherein the lower surface of the third tail 10-3A-T3 is flush with the lower surface of the second tail 10-1B-T2. In addition, the lower surface of the first tail 10-3A-T1 of the first signal terminal 10-3A is higher by H than the lower surface of the third tail 10-3A-T3 and does not serve as a mounting portion.

Although the third tail 10-3A-T3 and the first tail 10-3A-T1 are shown as overlapping each other in FIG. 7, the third tail 10-3A-T3 is located at the rear of the first tail 10-3A-T1 (that is, at the transverse inner side of the connector 10) and the first tail 10-3A-T1 is located in front of the third tail 10-3A-T3 (that is, at the transverse outer side of the connector 10), as can be readily understood from FIG. 2.

The purpose of this height difference H is to prevent electrical short between adjacent terminals during a surface mount technology (SMT) process. Solder paste or the like is used in SMT to join the second tail 10-3B-T2 of the second signal terminal 10-3B to a substrate (not shown). For example, when the connector 10 according to the present invention has a very small size to be used in applications such as smartphones, solder paste applied to the second tail 10-3B-T2 of one terminal can spread to the vicinity of another terminal adjacent thereto (that is, the first tail 10-3A-T1 of the first signal terminal 10-3A). This can result in electrical short between the terminals due to undesirable circuit connection.

In order to prevent such electrical short, in the present invention, the first tail 10-3A-T1 (not serving as a mounting portion) is positioned higher by H than the second tail 10-3B-T2 (serving as a mounting portion), as shown in FIG. 7. In addition, at least some of the height difference H corresponds to a height (depth) of the second groove 10-5-G2. Forming the second groove 10-5-G2 having a shape as shown in FIG. 5 to FIG. 7 can prevent solder wicking. That is, although the second groove 10-5-G2 does not serve to actively trap solder paste therein, when a small amount of solder paste inevitably spreads sideways from a portion of a neighboring terminal (that is, the second tail 10-3B-T2), the second groove 10-5-G2 or a region under the second groove 10-5-G2 can retain (or trap) some of the solder paste, thereby preventing the solder paste from reaching the first tail 10-3A-T1 (unless a large amount of the solder paste spreads from the neighboring terminal). In this way, the second groove 10-5-G2 can prevent electrical short between adjacent terminals.

That is, the height difference H and the relatively wide second groove 10-5-G2 cooperatively prevent solder wicking.

The first groove 10-5-G1 and the second groove 10-5-G2 may be formed by holding the first signal terminal 10-3A from above and below using tools during a resin molding process such that a resin is not molded in a place occupied by the tools, rather than by cutting or machining the housing 10-5, although the present invention is limited thereto.

Referring to FIG. 7, the first groove 10-5-G1 has a rounded shape. This shape results from the fact that one of the tools holding the first signal terminal 10-3A (that is, the tool holding the upper surface of the first tail 10-3A-T1) has a rounded shape.

Advantageously, the first groove 10-5-G1 and/or the second groove 10-5-G2 can serve to prevent solder wicking and thus electrical short between adjacent terminals while eliminating the need to increase the number of processes since the first groove 10-5-G1 and/or the second groove 10-5-G2 are formed by holding the first signal terminal 10-3A with tools having shapes corresponding thereto during the resin molding process without requiring a separate process. In short, the present invention can provide prevention of solder wicking and electrical short between adjacent terminals while not increasing the complexity of the manufacturing process.

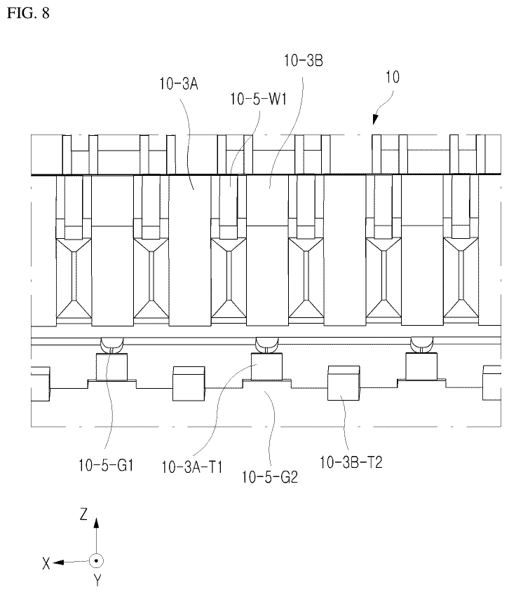

FIG. 8 is a view of the plug connector of FIG. 5 to FIG. 7 taken from yet another angle.

For example, when the transverse outer side of the plug connector of FIG. 7 is tilted slightly downwards, the plug connecter can be observed from the angle in FIG. 8.

Referring to FIG. 8, it can be seen that the upper surface of the first tail 10-3A-T1 is only partially exposed along a center line of the first groove 10-5-G1 (that is, the first groove 10-5-G1 is formed with a cut-out).

In addition, it can be seen that a relatively large area of the lower surface of the first tail 10-3A-T1 is exposed along the second groove 10-5-G2.

This is because, as described above, the first groove 10-5-G1 is formed during manufacture of the housing 10-5 (including the skirt 10-5-S) by introducing a resin into a mold cavity with the upper surface of the first tail 10-3A-T1 held by a tool (or instrument) having a rounded shape and with the lower surface of the first tail 10-3A-T1 held by a tool (or instrument) having a rectangular shape such that the resin is molded only in a region other than the tools.

In particular, it can be seen that the first groove 10-5-G1 has a rounded shape. This rounded shape can serve to prevent a short shot, that is, incomplete filling of a space around the first tail 10-3A-T1 stepped with respect to (having a height difference H from) the mounting portion (that is, the second tail 10-3B-T2) while aiding in correcting the position of the terminals.

That is, when only a linear portion of the upper surface of the first tail 10-3A-T1 is exposed due to the rounded shape of the first groove 10-5-G1, the first groove can not only more firmly hold the first signal terminal 10-3A (especially, the first tail 10-3A-T1), but also can aid in correcting the position of the first tail 10-3A-T1, as compared with when the upper surface of the first tail 10-3A-T1 is entirely exposed.

For reference, unlike the illustrated example, the second groove 10-5-G2 may have a rounded shape and the first groove 10-5-G1 may have a rectangular shape. However, in this case, the solder wicking prevention effect provided by the second groove 10-5-G2 is somewhat weakened. Since the second tail 10-3B-T2 is soldered on the lower surface thereof rather than on the upper surface thereof, there is a greater need to prevent solder wicking onto the lower surface of the first tail 10-3A-T1.

Accordingly, it is desirable that the second groove 10-5-G2 have a rectangular shape to expose a relatively large area of the first tail 10-3A-T1 so as to prevent solder wicking and the first groove 10-5-G1 have a rounded shape to expose a relatively small area of the first tail 10-3A-T1 so as to prevent short shot defects (that is, to ensure that a resin sufficiently covers the first tail 10-3A-T1) and to aid in correcting the position of the first tail 10-3A-T1 (that is, positioning the first tail 10-3A-T1 in place), although the present invention is not limited thereto.

In addition, although it has been described that the first groove 10-5-G has a rounded shape (a half-moon shape), the present invention is not necessarily limited thereto and the first groove 10-5-G may have any shape with a wide top and a narrow bottom (that is, a cut-out), for example, an inverted trapezoidal shape. That is, the shape of the first groove 10-5-G is not particularly restricted so long as the first groove 10-5-G can sufficiently cover the upper surface of the first tail 10-3A-T1 to firmly secure the first tail 10-3A-T1. To put it in an extreme way, the first groove 10-5-G1 may have an inverted triangular shape. However, since the shape of the first groove 10-5-G1 conforms to the shape of a tool holding the first tail 10-3A-T1 during manufacture of the housing 10-5 (or at least the skirt 10-5-S) by resin molding, it is not easy to hold the first tail 10-3A-T1 from above only with a bottom apex of an inverted triangular tool (despite there being another tool supporting the lower surface of the first tail 10-3A-T1 from below). Accordingly, it is desirable the first groove 10-5-G1 have a half-moon shape (if necessary, having a cut-out at a bottom thereof) or an inverted trapezoidal shape, although the present invention is not limited thereto.

In addition, the foregoing description of the plug connector 10 may also be applied to a receptacle connector (not shown) (a socket connector) to the extent that it is not contrary to the nature of the receptacle connector. That is, although the plug connector 10 has been illustrated and described hereinabove, the present invention should not be construed as being limited to the plug connector.

It should be understood that the foregoing is merely illustrative of the features and advantages of the present invention and is not intended to limit the present invention thereto.

Although some embodiments have been described herein in conjunction with the accompanying drawings, it should be understood that the present invention is not limited to the embodiments and may be embodied in different ways, and that various modifications, changes, alterations, and equivalent embodiments can be made by those skilled in the art without departing from the spirit and scope of the invention. Therefore, it should be understood that the foregoing embodiments are provided for illustration only and are not to be in any way construed as limiting the present invention.

### LIST OF REFERENCE NUMERALS

10: (Plug) connector
10-1: Power terminal
10-3: Signal terminal
10-3A: First signal terminal
10-3A-M: Mounting portion with respect to substrate (not shown)
10-3A-T1: First tail (not serving as mounting portion with respect to substrate)
10-3A-T3: Third tail (serving as mounting portion (10-3A-M) with respect to substrate (not shown)
10-3B: Second signal terminal
10-3B-M: Mounting portion with respect to substrate (not shown)
10-3B-T2: Second tail (serving as mounting portion (10-3B-M) with respect to substrate (not shown)
10-5: Housing (molded part)
10-5-B: Base
10-5-G1: First groove
10-5-G2: Second groove
10-5-PH: Through-hole (center hole)
10-5-W1: First wall
10-5-W2: Second wall
10-5-W3: Third wall
10-5-W4: Fourth wall

1. An electrical connector coupled with a mating connector, comprising:
a housing comprising a base, a first wall protruding from an upper surface of the base, a second wall protruding from the upper surface of the base and intersecting the first wall, a third wall protruding from the upper surface of the base, intersecting the second wall, and facing the first wall, a fourth wall protruding from the upper surface of the base, intersecting the first and third walls, and facing the second wall, and a skirt protruding outwards from the first and third walls in a transverse direction of the electrical connector; and
a plurality of first signal terminals and a plurality of second signal terminals formed at least on the first wall and arranged in a longitudinal direction of the electrical connector,
wherein the first signal terminal comprises a first bent portion, a first elongated portion, and a first tail,
the second signal terminal comprises a second bent portion, a second elongated portion, and a second tail,
the first tail and the second tail are disposed on the skirt, and
a lowermost surface of the first tail is higher than a lowermost surface of the second tail in a height direction of the electrical connector.

2. The electrical connector according to claim 1, wherein the first tail is not mounted on a substrate and the second tail is mounted on the substrate.

3. The electrical connector according to claim 1, wherein the second tail protrudes farther than the first tail in the transverse direction of the electrical connector.

4. The electrical connector according to claim 1, wherein the skirt comprises a first groove formed above the first tail, and the first groove has a cut-out such that an upper surface of the first tail is partially exposed through the cut-out of the first groove in top view.

5. The electrical connector according to claim 4, wherein the first groove has a semicircular shape in side view.

6. The electrical connector according to claim 1, wherein the skirt comprises a second groove formed under the first tail such that a lower surface of the first tail is at least partially exposed through the second groove in bottom view.

7. The electrical connector according to claim 6, wherein the second groove has a rectangular shape in side view.

8. The electrical connector according to claim 1, wherein the first elongated portion and the second elongated portion serve as contacts with a signal terminal of the mating connector.

9. The electrical connector according to claim 1, wherein the first signal terminal and the second signal terminal are arranged alternately in the longitudinal direction of the electrical connector.

10. The electrical connector according to claim 1, wherein the first signal terminal further comprises a third elongated portion and a third tail.
